(19) United States
(12) Patent Application Publication
(10) Pub. No.: US 2013/0138764 A1
(43) Pub. Date: May 30, 2013

(54) METHOD AND SYSTEM FOR VIRTUAL MACHINE DATA MIGRATION

(71) Applicant: Soumendu S. Satapathy, Rourkela (IN)

(72) Inventor: Soumendu S. Satapathy, Rourkela (IN)

(21) Appl. No.: 13/308,426

(22) Filed: Nov. 30, 2011

(51) Int. Cl. G06F 15/167

(52) U.S. Cl. 709/214

(57) ABSTRACT

A machine implemented method and system for a network executing a plurality of virtual machines accessing storage devices via a plurality of switches is provided. A management application determines a plurality of paths between a computing system executing the virtual machines and a storage device. Each path includes at least one switch that is configured to identify traffic related to a virtual machine. One of the paths is selected based on a path rank. The selected path is then used for transmitting data for migrating the virtual machine from a first storage device location to a second storage device location. A switch in the virtual network receives virtual machine data and is configured to differentiate between virtual machine data and other network traffic. The switch prioritizes transmission of virtual machine data compared to standard network traffic or non-virtual machine data.

### TECHNICAL FIELD

The present disclosure relates to computing systems.

### BACKGROUND

Various forms of storage systems are used today. These forms include direct attached storage (DAS) network attached storage (NAS) systems, storage area networks (SANs), and others. Network storage systems are commonly used for a variety of purposes, such as providing multiple users with access to shared data, backing up data and others.

A storage system typically includes at least one computing system executing a storage operating system for storing and retrieving data on behalf of one or more user computing systems. The storage operating system stores and manages shared data containers in a set of mass storage devices.

Storage systems are extensively used by users in NAS, SAN and virtual environments where a physical/hardware resource is simultaneously shared among a plurality of independently operating processor executable virtual machines. Typically, a hypervisor module presents the physical resources to the virtual machines. The physical resources may include one or more processors, memory and other resources, for example, input/output devices, host attached storage devices, network attached storage devices or other like storage. Storage space at one or more storage devices is typically presented to the virtual machines as a virtual storage device (or drive). Data for the virtual machines may be stored at various storage locations and migrated from one location to another.

Continuous efforts are being made to provide a non-disruptive storage operating environment such that when virtual machine data is migrated, there is less downtime and disruption for a user using the virtual machine. This is challenging because virtual machine data migration often involves migrating a large amount of data from one location to another via a plurality of switches and other network devices.

Conventional networks and network devices do not typically differentiate between virtual machine migration data and other standard network traffic. Typical network devices do not prioritize transmission of virtual machine migration data over other network traffic, which may slow down overall virtual machine migration and hence may result in undesirable interruption. The methods and systems described herein are designed to improve transmission of virtual machine migration data.

### SUMMARY

In one embodiment a machine implemented method and system for a network executing a plurality of virtual machines accessing storage devices via a plurality of switches is provided. A management application executed by a management console determines a plurality of paths between a computing system executing the plurality of virtual machines and a storage device. Each path includes at least one switch that is configured to identify traffic related to a virtual machine. One of the paths is selected based on a path rank and a virtual network is generated having a plurality of network elements in the selected path. The selected path is then used for transmitting data for migrating the virtual machine from a first storage device location to a second storage device location.

A switch in the virtual network receives virtual machine data and is configured to differentiate between virtual machine data and other network traffic. The switch prioritizes transmission of virtual machine data compared to standard network traffic or non-virtual machine data.

In one embodiment, virtual machine data is transmitted via a network that is configured to recognize virtual machine migration and prioritize transmission of virtual machine data over standard network traffic. This allows a system to efficiently migrate virtual machine data without having to compete for bandwidth with non-virtual machine data. This results is less downtime and improves overall user access to virtual machines and storage space.

In another embodiment, a machine implemented method for a network executing a plurality of virtual machines accessing storage devices via a plurality of switches. The method includes generating a virtual network data structure for a virtual network for identifying a plurality of network elements in a selected path from among a plurality of paths between a computing system executing the plurality of virtual machines and a storage device. Each path is ranked by a path rank and includes at least one switch that can identify traffic related to a virtual machine. The method further includes using the selected path for transmitting data for migrating the virtual machine from a first storage device location to a second storage device location.

In yet another embodiment, a machine implemented method for a network executing a plurality of virtual machines accessing storage devices via a plurality of switches is provided. The method includes determining a plurality of paths between a computing system executing the plurality of virtual machines and a storage device, where each path includes at least one switch that can identify traffic related to a virtual machine; selecting one of the paths from the plurality of paths based on a path rank; generating a virtual network data structure for a virtual network for identifying a plurality of network elements in the selected path; and using the selected path for migrating the virtual machine from a first storage device location to a second storage device location.

In another embodiment, a system is provided. The system includes a computing system executing a plurality of virtual machines accessing a plurality of storage devices; a plurality of switches used for accessing the plurality of storage devices; and a management console executing a management application.

The management application determines a plurality of paths between the computing system and a storage device and each path includes at least one switch that can identify traffic related to a virtual machine; selects one of the paths from the plurality of paths based on a path rank; and generates a virtual network data structure for a virtual network identifying a plurality of network elements in the selected path; and the selected path is used for transmitting data for migrating the virtual machine from a first storage device location to a second storage device location.

This brief summary has been provided so that the nature of this disclosure may be understood quickly. A more complete understanding of the disclosure can be obtained by reference to the following detailed description of the various embodiments thereof in connection with the attached drawings.

### BRIEF DESCRIPTION OF THE DRAWINGS

The foregoing features and other features will now be described with reference to the drawings of the various embodiments. In the drawings, the same components have the same reference numerals. The illustrated embodiments are intended to illustrate, but not to limit the present disclosure. The drawings include the following Figures:

FIG. 1A shows an example of an operating environment for the various embodiments disclosed herein;

FIG. 1B shows an example of a management application, according to one embodiment;

FIG. 1C shows an example of a path data structure maintained by a management application, according to one embodiment;

FIG. 1D shows an example of a data structure for creating a virtual network, according to one embodiment;

FIGS. 1E and 1F show process flow diagrams, according to one embodiment;

FIG. 1G shows an example of a tagged data packet, according to one embodiment;

FIG. 1H shows an example of a switch used according to one embodiment;

FIG. 2 shows an example of a storage system, used according to one embodiment;

FIG. 3 shows an example of a storage operating system, used according to one embodiment; and

FIG. 4 shows an example of a processing system, used according to one embodiment.

### DETAILED DESCRIPTION

As preliminary note, the terms “component”, “module”, “system,” and the like as used herein are intended to refer to a computer-related entity, either software-executing general purpose processor, hardware, firmware and a combination thereof. For example, a component may be, but is not limited to being, a process running on a processor, a processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, on computer readable media including, but not limited to, an ASIC (application specific integrated circuit), CD (compact disc), DVD (digital video disk), ROM (read only memory), floppy disk, hard disk, solid state memory (e.g., flash), EEPROM (electrically erasable programmable read only memory), memory stick or any other storage device type, in accordance with the claimed subject matter.

In one embodiment a machine implemented method and system for a network executing a plurality of virtual machines (VMs) accessing storage devices via a plurality of switches is provided. A management application executed by a management console determines a plurality of paths between a computing system executing the VMs and a storage device. Each path includes at least one switch that is configured to identify traffic related to a VM. One of the paths is selected based on a path rank and a virtual network is generated having a plurality of network elements in the selected path. The selected path is then used for transmitting data for migrating the VM from a first storage device location to a second storage device location.

A switch in the virtual network receives VM data and is configured to differentiate between VM data and other network traffic. The switch prioritizes transmission of VM data compared to standard network traffic or non-virtual machine data.

System 100:

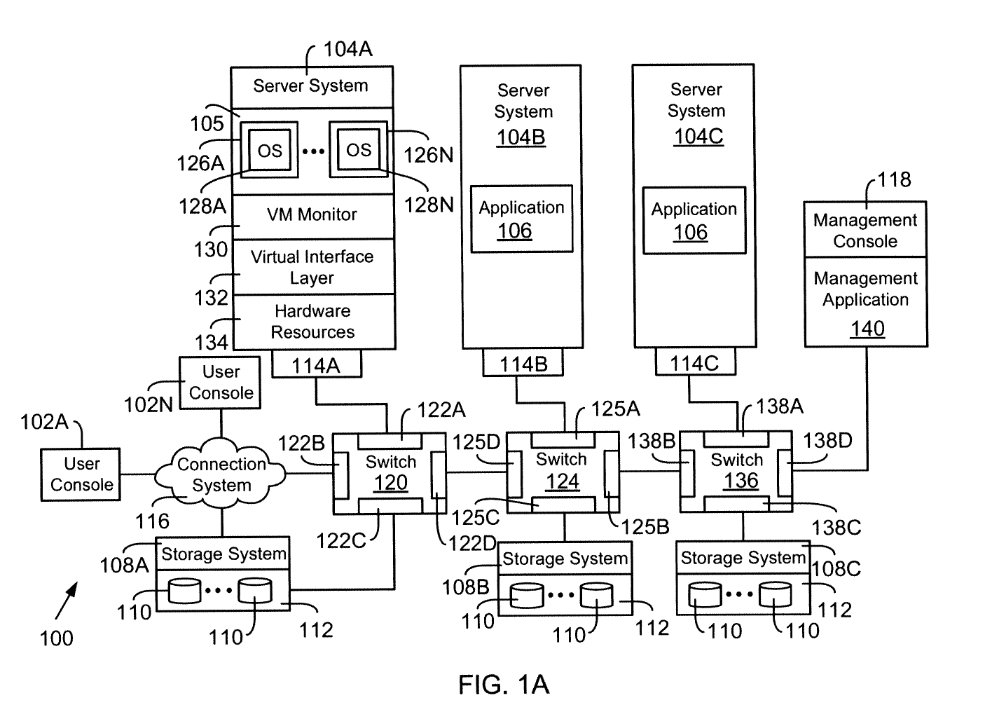

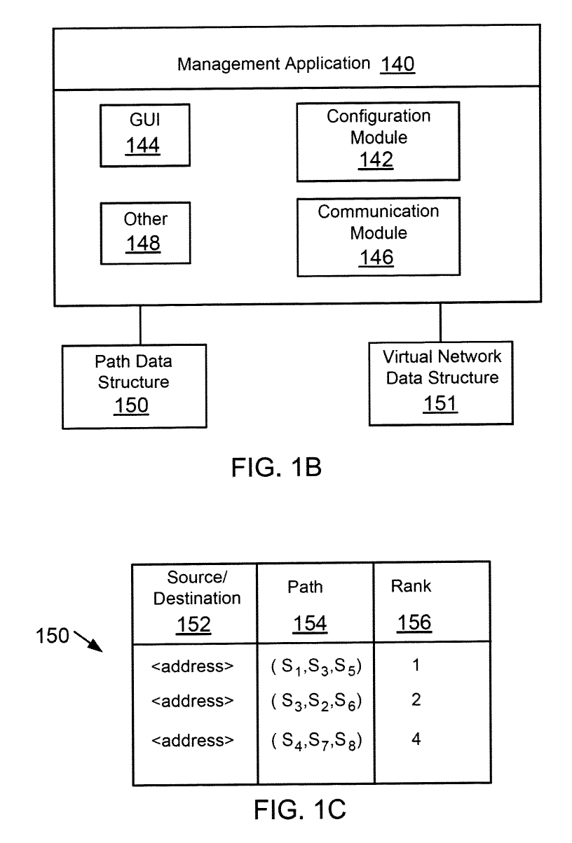

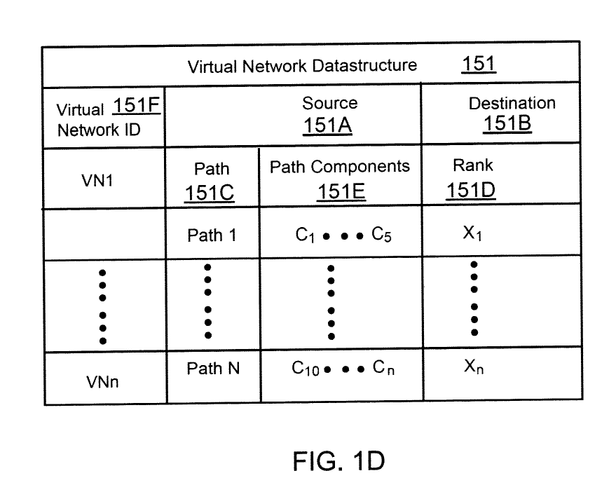

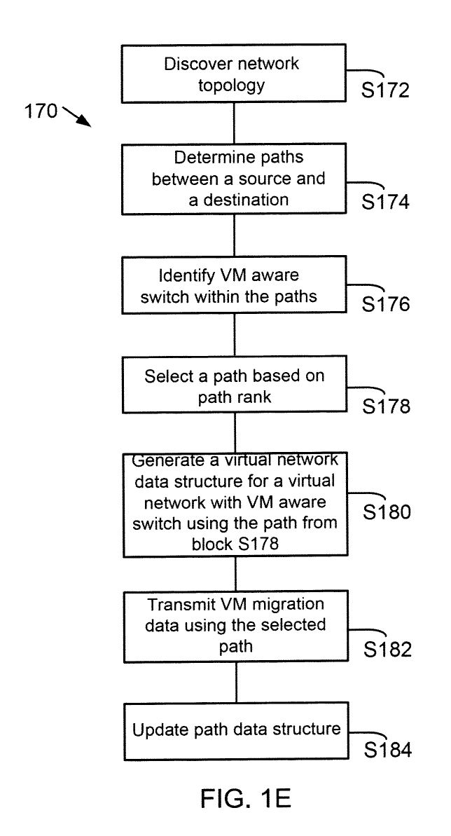

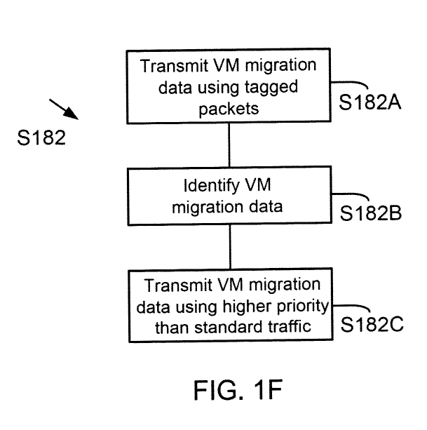

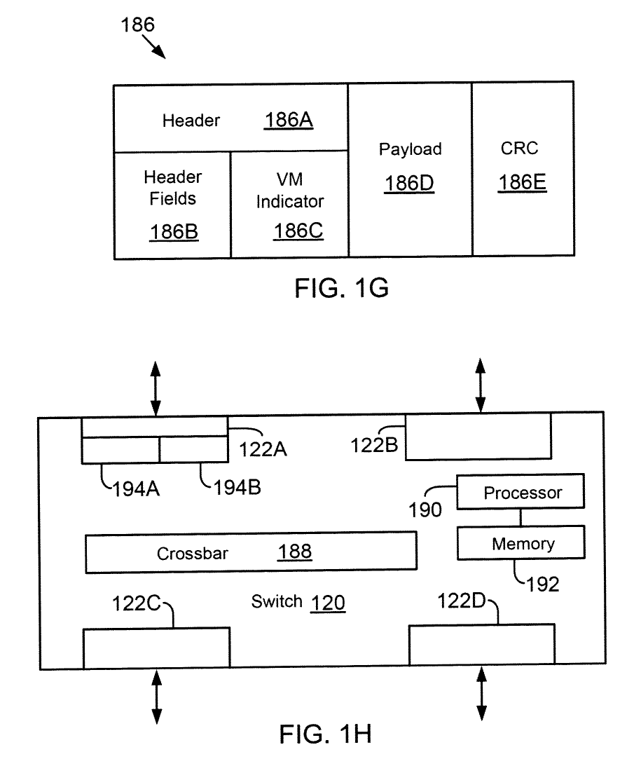

FIG. 1A shows an example of an operating environment 100 (also referred to as system 100), for implementing the adaptive embodiments disclosed herein. The operating environment includes server systems executing VMs that are presented with virtual storage, as described below. Data may be stored by a user using a VM at a storage device managed by a storage system. The user data as well configuration information regarding the VM (jointly referred to herein as VM data or VM migration data) may be migrated (or moved) from one storage location to another. The embodiments described below provide an efficient method and system for migrating VM data.

In one embodiment, system 100 may include a plurality of computing systems 104A-104C (may also be referred to as server system 104 or as host system 104) that may access one or more storage systems 108A-108C (may be referred to as storage system 108) that manage storage devices 110 within a storage sub-system 112. The server systems 104A-104C may communicate with each other for working collectively to provide data-access service to user consoles 102A-102N via a connection system 116 such as a local area network (LAN), wide area network (WAN), the Internet or any other network type.

Server systems 104A-104C may be general-purpose computers configured to execute applications 106 over a variety of operating systems, including the UNIX® and Microsoft Windows® operating systems. Application 106 may utilize data services of storage system 108 to access, store, and manage data at storage devices 110. Application 106 may include an email exchange application, a database application or any other type of application. In another embodiment, application 106 may comprise a VM as described below in more detail.

Server systems 104 generally utilize file-based access protocols when accessing information (in the form of files and directories) over a network attached storage (NAS)-based network. Alternatively, server systems 104 may use block-based access protocols, for example, the Small Computer Systems Interface (SCSI) protocol encapsulated over TCP (iSCSI) and SCSI encapsulated over Fibre Channel (FCP) to access storage via a storage area network (SAN).

In one embodiment, storage devices 110 are used by storage system 108 for storing information. The storage devices 110 may include writable storage device media such as magnetic disks, video tape, optical, DVD, magnetic tape, non-volatile memory devices for example, self-encrypting drives, flash memory devices and any other similar media adapted to store information. The storage devices 110 may be organized as one or more groups of Redundant Array of Independent Inexpensive) Disks (RAID). The embodiments disclosed herein are not limited to any particular storage device or storage device configuration.

In one embodiment, to facilitate access to storage devices 110, a storage operating system of storage system 108 “virtualizes” the storage space provided by storage devices 110. The storage system 108 can present or export data stored at storage devices 110 to server systems 104 as a storage object such as a volume or one or more qtree sub-volume units. Each storage volume may be configured to store data files (or data containers or data objects), scripts, word processing documents, executable programs, and any other type of structured or unstructured data. From the perspective of the server systems, each volume can appear to be a single storage device, storage container, or storage location. However, each volume can represent the storage space in one storage device, an aggregate of some or all of the storage space in multiple storage devices, a RAID group, or any other suitable set of storage space.

It is noteworthy that the term “disk” as used herein is intended to mean any storage device/space and not to limit the adaptive embodiments to any particular type of storage device, for example, hard disks.

The storage system 108 may be used to store and manage information at storage devices 110 based on a request generated by server system 104, a management console 118 or user console 102. The request may be based on file-based access protocols, for example, the Common Internet File System (CIFS) or the Network File System (NFS) protocol, over TCP/IP. Alternatively, the request may use block-based access protocols, for example, iSCSI or FCP.

As an example, in a typical mode of operation, server system 104 (or VMs 126A-126N described below) transmits one or more input/output (I/O) commands, such as an NES or CIFS request, to the storage system 108. Storage system 108 receives the request, issues one or more I/O commands to storage devices 110 to read or write the data on behalf server system 104, and issues an NFS or CIFS response containing the requested data to the respective server system 104.

In one embodiment, storage system 108 may have distributed architecture, for example, a cluster based system that may include a separate N-(“network”) blade or module and D-(data) blade or module. Briefly, the N-blade is used communicate with host platform server system 104 and management console 118, while the O-blade is used to communicate with the storage devices 110 that are a part storage sub-system or other O-blades. The N-blade and O-blade may communicate with each other using an internal protocol.

Server 104 may also execute a virtual machine environment 105, according to one embodiment. In the virtual machine environment 105 a physical resource is time-shared among a plurality of independently operating processor executable VMs 126A-126N. Each VM may function as a self-contained platform or processing environment, running its own operating system (OS) (128A-128N) and computer executable, application software. The computer executable instructions running in a VM may be collectively referred to herein as “guest software”. In addition, resources available within the VM may be referred to herein as “guest resources”.

The guest software expects to operate as if it were running on a dedicated computer rather than in a VM. That is, the guest software expects to control various events or operations and have access to hardware resources 134 on a physical computing system (may also be referred to as a host platform) which maybe referred to herein as “host hardware resources”. The hardware resources 134 may include one or more processors, resources resident on the processors (e.g., control registers, caches and others), memory (instructions residing in memory, e.g., descriptor tables), and other resources (e.g., input/output devices, host attached storage, network attached storage or other like storage) that reside in a physical machine or are coupled to the host platform.

A virtual machine monitor (VMM) 130, for example, a processor executed hypervisor layer provided by VMWare Inc., Hyper-V layer provided by Microsoft Corporation or any other layer type, presents and manages the plurality of guest OS 128A-128N. The VMM 130 may include or interface with a virtualization layer (VIL) 132 that provides one or more virtualized hardware resource 134 to each guest OS. For example, VIL 132 presents physical storage at storage devices 110 as virtual storage for example, as a virtual storage device or virtual hard drive (VHD) file to VMs 126A-126N. The VMs then store information in the VHDs which are in turn stored at storage devices 110.

In one embodiment, VMM 130 is executed by server system 104 with VMs 126A-126n. In another embodiment, VMM 130 may be executed by an independent stand-alone computing system, often referred to as a hypervisor server or VMM server and VMs 126A-126N are presented via another computing system. It is noteworthy that various vendors provide virtualization environments, for example, VMware Corporation, Microsoft Corporation and others. The generic virtualization environment described above with respect to FIG. 1A may be customized depending on the virtual environment provider.

Data associated with a VM may be migrated from one storage device location to another storage device location. Often this involves migrating the VHD file and all the user data stored with respect to the VHD (referred to herein as VM data or VM migration data). VM providers strive to provide a seamless experience to users and attempt to migrate VM data with minimal disruption. Hence the various components of FIG. 1A, may need to prioritize VM data migration. The embodiments disclosed herein and described below in detail prioritize transmission of VM migration data.

Server systems 104A-104C may use (e.g., network and/or or storage) adapters 114A-114C to access storage systems 108 via a plurality of switches, for example, switch 120, switch 124 and switch 136. Each switch may have a plurality of ports for sending and receiving information. For example, switch 120 includes ports 122A-122D, switch 124 includes ports 125A-125D and switch 136 includes ports 138A-138D. The term port as used herein includes logic and circuitry for processing received information. The adaptive embodiments disclosed herein are not limited to any particular number of adapters/switches and/or adapter/switch ports.

In one embodiment, port 122A may be operationally coupled to adapter 114A of server system 104A. Port 122B is coupled to connection system 116 and provides access to user console 102A-102N. Port 122C may be coupled to storage system 108A. Port 122D may be coupled to port 125D of switch 124.

Port 125A may be coupled to adapter 114B of server system 104B, while port 125B is coupled to port 136B of switch 136. Port 125C is coupled to storage system 108B for providing access to storage devices 110.

Port 138A may be coupled to adapter 1140 of server system 104C. Port 138C may be coupled to another storage system 108C for providing access to storage in a SAN environment. Port 138D may be coupled to the management console 118 for providing access to network path information, as described below in more detail.

The management console 118 executing a processor-executable management application 140 is used for managing and configuring various elements of system 100. Management application 140 may be used to generate a virtual network for transmitting VM migration data, as described below in detail. Details regarding management application 140 are provided below in more detail.

Management Application 140:

FIG. 1B shows a block diagram of management application 140 having a plurality of modules, according to one embodiment. The various modules may be implemented in one computing system or in a distributed environment among multiple computing systems.

In one embodiment, management application 140 discovers the network topology of system 100. Management application 140 discovers network devices that are can differentiate between VM migration data and other standard network traffic. Management application 140 creates a virtual network having a plurality of paths that can be used for transmitting VM migration data at a higher priority than standard network traffic. Management application 140 maintains various data structures for such virtual networks, as described below in detail.

In the illustrated embodiment, the management application 140 may include a graphical user interface (GUI) module 144 to generate a GUI for use by a storage administrator or a user using a user console 102. In another embodiment, management application 140 may present a command line interface (CLI) to a user. The GUI may be used by a user to configure the various components of system 100, for example, switches 120, 124 and 136, storage devices 110 and others.

Management application 140 may include a communication module 146 that implements one or more conventional communication protocols and/or APIs to enable the various modules of management application 140 to communicate with the storage system 108, VMs 126A-126N, switch 120, switch 126, switch 136, server system 104 and user console 102.

Management application 140 also includes a processor executable configuration module 142 that stores configuration information for storage devices 110 and switches 120, 124 and 136. In one embodiment, configuration module 142 also maintains a virtual network data structure 151 and a path data structure 150 shown in FIGS. 1C and 1D, respectively.

Path data structure 150 shown in FIG. 1C may include a plurality of fields 152-156. Field 152 stores the source and destination addresses. The source address in this example includes the address of a system executing a VM and destination address is the address of a storage device where VM data is migrated.

Field 154 stores various paths between the source and the destination. The paths are ranked in field 156. When the path data structure 150 is initially generated by management application 140, each path may be assigned a programmable default rank. When a particular path is successfully used to transmit VM migration data, then the path rank for that path is increased by management application 140 (for example, by the configuration module 142). The path rank is also decreased when a path is unsuccessful in completing a migration operation. Thus over time, the path ranks in the path data structure 150 reflect the historical success or failure of migration operations using the various available paths.

The virtual network data structure 151 stores an identifier for identifying each virtual network in segment 151F of FIG. 10. The virtual network means a logical network/data structure that is generated by management application 140 based on a selected path for transmitting VM migration data via the selected path. As an example, the virtual networks are identified as VN1-VNn. The source and destination addresses may be stored in segments 151A and 151B as shown in FIG. 1D. Segment 151C shows the various paths between a source and destination, with the path components, shown in segment 151E. The path rank for each path is shown in segment 151D. The process for generating the virtual network data structure 151 is described below in detail. Although the virtual network data structure 151 is shown to include information regarding a plurality of virtual networks, in one embodiment, an instance of virtual network data structure may be generated by management application 140 for storing information regarding a virtual network.

It is noteworthy that although path data structure 150 and virtual network data structure 151, as an example, are shown as separate data structures, they may very well be implemented into a single data structure or more than two data structures.

Management application 140 may also include other modules 138. The other modules 148 are not described in detail because the details are not germane to the inventive embodiments.

The functionality of the various modules of management application 140 and path data structure 150 is described below in detail with respect to the various process flow diagrams.

Process Flow:

FIG. 1E shows a process 170 for generating a virtual network for transmitting VM migration data using a selected path having a VM aware switch, according to one embodiment. The process begins in block 5172, when management application 140 discovers the overall network topology of system 100. In one embodiment, configuration module 142 using communication module 146 transmits discovery packets to discover various network devices, including adapters' 114A-114C and switches 120, 124 and 136 and information regarding how the devices are connected to each other. A discovery packet typically seeks identification and connection information from the network devices. The identification information may include information that identifies various adapter and switch ports, for example, the world wide port numbers (WWPNs). The connection information identifies how the various devices/ports may be connected to each other. The discovery packet format/mechanism is typically defined by the protocol/standard used by the adapters/switches, for example, FC, iSCSI, FCoE and others.

In block S174, based on the network topology, management application 140 determines the various paths that may exist between a source and a destination device. The network topology typically identifies the various devices that are used to connect the source and the destination device and based on that information management application 140 determines the various paths. For example, management application 140 is aware of the various devices between server system 104A (a source device) and the storage system 108A (a destination device). Based on the topology information, management application 140 ascertains the various paths between server system 104A and the storage system 108A coupled to port 122C of switch 120. For example, a first path may use both switch 120 and switch 124, while a second path may only use switch 120.

In block S176, management application 176 identifies one or more switch within the paths identified in block S174 that are configured to recognize VM migration data. Such a switch may be referred to as a VM aware switch. A VM aware switch, as described below is typically pre-configured to recognize VM migration traffic. In one embodiment, management application 140 may send a special discovery packet to all the switches. The discovery packet solicits a particular response to determine if the switch is VM aware. Any switch that is VM aware is configured to provide the expected response.

In block S178, management application 140 selects a path having a VM aware switch based on a path rank from the path data structure 150. The path data structure 150 is generated after the management application 140 determines the various paths in block S176. As described above, when the path data structure 150 is initially generated, all paths may have the same default rank and a path may be picked arbitrarily. The path data structure 150 is updated in real time, after each migration attempt. A path rank for a path that provides successful migration is increased, while a path rank for a path that provides an unsuccessful migration is decreased. Thus, over time, different paths may have different ranks based on successful and unsuccessful migration operations.

In block S180, management application 140 generates a virtual network using the selected path from block S178. The virtual network is a logical network that is used by the management application 140 to transmit VM migration data via the selected path. The attributes of the virtual network, for example, a virtual network identifier, the components within the selected path and the path rank of the selected path are stored at the virtual network data structure 151 described above with respect to FIG. 1D.

In block S182, when a migration request is received from a source to migrate VM data, then the selected path information is obtained from the virtual network data structure 151. VM data is then transmitted to the destination using the selected path. The process for handling the VM data is described in FIG. 1F.

Typically, after a migration job is complete, a message is sent by the storage system to the management application 140 notifying that the migration is complete. The storage system also notifies the management application 140 if the migration is not completed or fails. If the migration in block S182 is unsuccessful, then in block S184, the path data structure 150 is updated such that the path rank for the selected path is lowered. The process then reverts back to block S182, when a next path is selected for transmitting the migration data.

FIG. 1F shows a block diagram for transmitting VM migration data. The process begins in block S182A when VM migration data is transmitted as tagged data packets.

An example of a tagged data packet 186 is provided in FIG. 1G. Tagged data packet 186 includes a header 186A. The header may include certain fields 186B. These fields are based on the protocol/standard used for transmitting the migration data. Header 186A also includes a VM data indicator 186C. This indicates to the network device (for example, a switch and/or an adapter) that the packet involves a VM or includes VM migration data. Packet 186 may further include a payload 186D, which includes VM migration data. Packet 186 may further include cyclic redundancy code (CRC) 186E for error detection and maintaining data integrity.

In block S182B, the switch, for example, 120, receiving the tagged packet, identify VM migration data by recognizing VM indicator 186C. In block S182C, the switch transmits the VM migration data using a higher priority than standard network traffic. Typically, standard network packets are not tagged and only include header fields 186B without VM data indicator 186C. A switch port is configured to recognize incoming data packets with only header 186B as well as with the VM indicator 186C. In one embodiment, switch 120 uses a high priority and a low priority queue to segregate packet transmission. FIG. 1H shows an example of switch 120 using the high priority and low priority queues, according to one embodiment.

As an example, port 122A of switch 120 receives VM migration data packets 186 with VM indicator 186C. Port 122A maintains a high priority queue 194A and a low priority queue 194B. When tagged packet 186 is received, logic at port 122 is configured to place the packet at the high priority queue 194A.

Switch 120 also includes a crossbar 188 for transmitting packets between ports 122A-122D. A crossbar is typically a hardware component of a switch that enables communication between the various ports. For example, if port 122A has to send a packet to port 122C for transmission to storage system 108A, then the logic and circuitry (not shown) of cross-bar 188 is used to transmit the packet from port 122A to 122C.

Switch 120 also includes a processor 190 with access to a switch memory 192 that stores firmware instructions for controlling overall switch 120 operations. In one embodiment, memory 192 includes instructions for recognizing VM indicator 186C and then prioritizing transmission of VM migration data by using the high priority queue 194A.

In one embodiment, the virtual network having at least a VM aware switch prioritizes transmission of VM migration data. This results in efficiently transmitting a large amount of data, which reduces downtime to migrate a VM from one location to another. This reduces any disruption to a user using the VM and the associated storage.

Storage System:

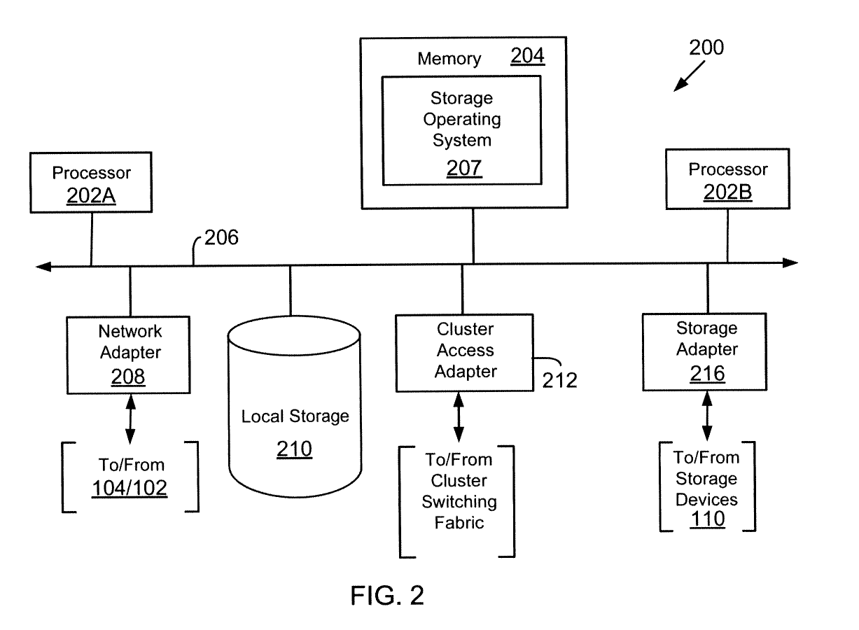

FIG. 2 is a block diagram of a computing system 200 (also referred to as system 200), according to one embodiment. System 200 may be used by a stand-alone storage system 108 and/or a storage system node operating within a cluster based storage system. System 200 is accessible to server system 104, user console 102 and/or management console 118 via various switch ports shown in FIG. 1A and described above. System 200 is used for migrating VM data. System 200 may also be used to notify management application 140 when a migration operation is successfully completed or when it fails.

As described above storage space is presented to a plurality of VMs as a VHD file and the data associated with the VHD file is migrated from one storage location to another location based on the path selection methodology described above. The storage space is managed by computing system 200.

System 200 may include a plurality of processors 202A and 202B, a memory 204, a network adapter 208, a cluster access adapter 212 (used for a cluster environment), a storage adapter 216 and local storage 210 interconnected by a system bus 206. The local storage 210 comprises one or more storage devices, such as disks, utilized by the processors to locally store configuration and other information.

The cluster access adapter 212 comprises a plurality of ports adapted to couple system 200 to other nodes of a cluster (not shown). In the illustrative embodiment, Ethernet may be used as the clustering protocol and interconnect media, although it will be apparent to those skilled in the art that other types of protocols and interconnects may be utilized within the cluster architecture described herein.

System 200 is illustratively embodied as a dual processor storage system executing a storage operating system 207 that preferably implements a high-level module, such as a file system, to logically organize information as a hierarchical structure of named directories, files and special types of files called virtual disks (hereinafter generally “blocks”) on storage devices 110. However, it will be apparent to those of ordinary skill in the art that the system 200 may alternatively comprise a single or more than two processor systems. Illustratively, one processor 202 executes the functions of an N-module on a node, while the other processor 202B executes the functions of a D-module.

The memory 204 illustratively comprises storage locations that are addressable by the processors and adapters for storing programmable instructions and data structures. The processor and adapters may, in turn, comprise processing elements and/or logic circuitry configured to execute the programmable instructions and manipulate the data structures. It will be apparent to those skilled in the art that other processing and memory means, including various computer readable media, may be used for storing and executing program instructions pertaining to the invention described herein.

The storage operating system 207, portions of which is typically resident in memory and executed by the processing elements, functionally organizes the system 200 by, inter alia, invoking storage operations in support of the storage service provided by storage system 108. An example of operating system 207 is the DATA ONTAP® (Registered trademark of NetApp, Inc. operating system available from NetApp, Inc. that implements a Write Anywhere File Layout (WAFL® (Registered trademark of NetApp, Inc.)) file system. However, it is expressly contemplated that any appropriate storage operating system may be enhanced for use in accordance with the inventive principles described herein. As such, where the term “ONTAP” is employed, it should be taken broadly to refer to any storage operating system that is otherwise adaptable to the teachings of this invention.

The network adapter 208 comprises a plurality of ports adapted to couple system 200 to one or more systems (e.g. 104/102) over point-to-point links, wide area networks, virtual private networks implemented over a public network (Internet) or a shared local area network. The network adapter 208 thus may comprise the mechanical, electrical and signaling circuitry needed to connect storage system 108 to the network. Illustratively, the computer network may be embodied as an Ethernet network or a FC network.

The storage adapter 216 cooperates with the storage operating system 207 executing on the system 200 to access information requested by the server systems 104 and management console 118 (FIG. 1A). The information may be stored on any type of attached array of writable storage device media such as video tape, optical, DVD, magnetic tape, bubble memory, electronic random access memory, flash memory devices, micro-electro mechanical and any other similar media adapted to store information, including data and parity information.

The storage adapter 216 comprises a plurality of ports having input/output (I/O) interface circuitry that couples to the disks over an I/O interconnect arrangement, such as a conventional high-performance, FC link topology.

In another embodiment, instead of using a separate network and storage adapter, a converged adapter is used to process both network and storage traffic.

Operating System:

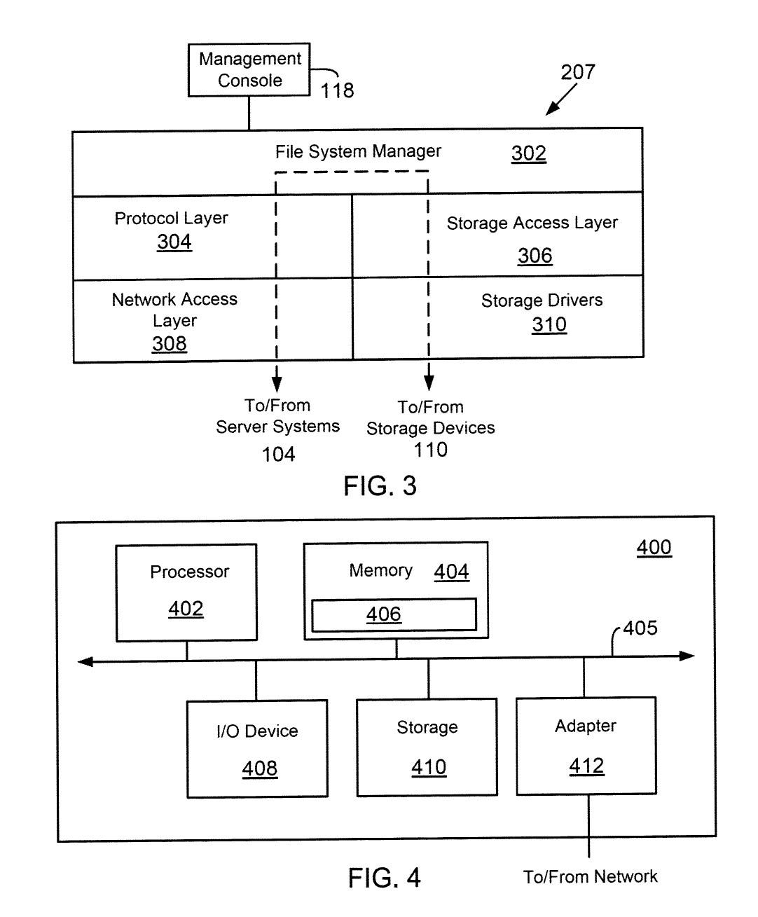

FIG. 3 illustrates a generic example of operating system 207 executed by storage system 108, according to one embodiment of the present disclosure. Storage operating system 207 manages storage space that is presented to VMs as VHD files. The data associated with the VHD files as well user data stored and managed by storage operating system 207 is migrated using the path selection methodology described above.

As an example, operating system 207 may include several modules, or “layers”. These layers include a file system manager 302 that keeps track of a directory structure (hierarchy) of the data stored in storage devices and manages read/write operations, i.e. executes read/write operations on storage devices in response to server system 104 requests.

Operating system 207 may also include a protocol layer 304 and an associated network access layer 308, to allow system 200 to communicate over a network with other systems, such as server system 104, clients 102 and management console 118. Protocol layer 304 may implement one or more of various higher-level network protocols, such as NFS, CIFS, Hypertext Transfer Protocol (HTTP), TCP/IP and others, as described below.

Network access layer 308 may include one or more drivers, which implement one or more lower-level protocols to communicate over the network, such as Ethernet. Interactions between server systems 104 and mass storage devices 110 are illustrated schematically as a path, which illustrates the flow of data through operating system 207.

The operating system 207 may also include a storage access layer 306 and an associated storage driver layer 310 to communicate with a storage device. The storage access layer 306 may implement a higher-level disk storage protocol, such as RAID, while the storage driver layer 310 may implement a lower-level storage device access protocol, such as FC or SCSI.

It should be noted that the software “path” through the operating system layers described above needed to perform data storage access for a client request may alternatively be implemented in hardware. That is, in an alternate embodiment of the disclosure, the storage access request data path may be implemented as logic circuitry embodied within a field programmable gate array (FPGA) or an ASIC. This type of hardware implementation increases the performance of the file service provided by storage system 108.

As used herein, the term “storage operating system” generally refers to the computer-executable code operable on a computer to perform a storage function that manages data access and may, in the case of system 200, implement data access semantics of a general purpose operating system. The storage operating system can also be implemented as a microkernel, an application program operating over a general-purpose operating system, such as UNIX® or Windows XP®, or as a general-purpose operating system with configurable functionality, which is configured for storage applications as described herein.

In addition, it will be understood to those skilled in the art that the invention described herein may apply to any type of special-purpose (e.g., file server, filer or storage serving appliance) or general-purpose computer, including a standalone computer or portion thereof, embodied as or including a storage system. Moreover, the teachings of this disclosure can be adapted to a variety of storage system architectures including, but not limited to, a network-attached storage environment, a storage area network and a disk assembly directly-attached to a client or host computer. The term “storage system” should therefore be taken broadly to include such arrangements in addition to any subsystems configured to perform a storage function and associated with other equipment or systems.

Processing System:

FIG. 4 is a high-level block diagram showing an example of the architecture of a processing system, at a high level, in which executable instructions as described above can be implemented. The processing system 400 can represent modules of management console 118, clients 102, server systems 104 and others. Processing system 400 may be used to maintain the virtual network data structure 151 and the path data structure 150 for generating a virtual network as well as selecting a path for transmitting VM migration data, as described above in detail. Note that certain standard and well-known components which are not germane to the present invention are not shown in FIG. 4.

The processing system 400 includes one or more processors 402 and memory 404, coupled to a bus system 405. The bus system 405 shown in FIG. 4 is an abstraction that represents any one or more separate physical buses and/or point-to-point connections, connected by appropriate bridges, adapters and/or controllers. The bus system 405, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The processors 402 are the central processing units (CPUs) of the processing system 400 and, thus, control its overall operation. In certain embodiments, the processors 402 accomplish this by executing programmable instructions stored in memory 404. A processor 402 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 404 represents any form of random access memory (RAM), read-only memory (ROM), flash memory, or the like, combination of such devices. Memory 404 includes the main memory of the processing system 400. Instructions 406 which implements techniques introduced above may reside in and may be executed (by processors 402) from memory 404. For example, instructions 406 may include code for executing the process steps of FIGS. 1E and 1F.

Also connected to the processors 402 through the bus system 405 are one or more internal mass storage devices 410, and a network adapter 412. Internal mass storage devices 410 may be or may include any conventional medium for storing large volumes of data in a non-volatile manner, such as one or more magnetic or optical based disks. The network adapter 412 provides the processing system 400 with the ability to communicate with remote devices (e.g., storage servers) over a network and may be, for example, an Ethernet adapter, a FC adapter, or the like. The processing system 400 also includes one or more input/output (I/O) devices 408 coupled to the bus system 405. The I/O devices 408 may include, for example, a display device, a keyboard, a mouse, etc.

Cloud Computing:

The system and techniques described above are applicable and useful in the upcoming cloud computing environment. Cloud computing means computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. The term “cloud” is intended to refer to the Internet and cloud computing allows shared resources, for example, software and information to be available, on-demand, like a public utility.

Typical cloud computing providers deliver common business applications online which are accessed from another web service or software like a web browser, while the software and data are stored remotely on servers. The cloud computing architecture uses a layered approach for providing application services. A first layer is an application layer that is executed at client computers. In this example, the application allows a client to access storage via a cloud.

After the application layer, is a cloud platform and cloud infrastructure, followed by a “server” layer that includes hardware and computer software designed for cloud specific services. The management console 118 (and associated methods thereof) and storage systems described above can be a part of the server layer for providing storage services. Details regarding these layers are not germane to the inventive embodiments.

Thus, a method and apparatus for transmitting VM migration data have been described. Note that references throughout this specification to “one embodiment” or “an embodiment” mean that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics being referred to may be combined as suitable in one or more embodiments of the invention, as will be recognized by those of ordinary skill in the art.

While the present disclosure is described above with respect to what is currently considered its preferred embodiments, it is to be understood that the disclosure is not limited to that described above. To the contrary, the disclosure is intended to cover various modifications and equivalent arrangements within the spirit and scope of the appended claims.

What is claimed is:

1. A machine implemented method for a network executing a plurality of virtual machines accessing storage devices via a plurality of switches, comprising:
determining a plurality of paths between a computing system executing the plurality of virtual machines and a storage device; wherein each path includes at least one switch that can identify traffic related to a virtual machine;
selecting one of the paths from the plurality of paths based on a path rank;
generating a virtual network data structure for a virtual network for identifying a plurality of network elements in the selected path; and
using the selected path for migrating the virtual machine from a first storage device location to a second storage device location.

2. The method of claim 1, wherein the path rank is maintained in a searchable data structure by a processor executable application.

3. The method of claim 2, wherein the path rank is lowered when an attempt to transmit virtual machine migration data fails.

4. The method of claim 1, wherein a processor executable application maintains attributes of the virtual network in the virtual network data structure.

5. The method of claim 4, wherein the attributes include virtual network identifier; information regarding a plurality of components within the selected path of the virtual network and a path rank for the selected path.

6. The method of claim 1, wherein the path rank is based on a success rate and a failure rate for transmitting data for the virtual machine.

7. The method of claim 1, wherein a switch in the selected path identifies data for migrating the virtual machine and transmits the data using a higher priority than non-virtual machine migration data.

8. A system, comprising:
a computing system executing a plurality of virtual machines accessing a plurality of storage devices;
a plurality of switches used for accessing the plurality of storage devices; and
a management console executing a management application;
wherein the management application determines a plurality of paths between the computing system and a storage device and each path includes at least one switch that can identify traffic related to a virtual machine; selects one of the paths from the plurality of paths based on a path rank; and generates a virtual network data structure for a virtual network identifying a plurality of network elements in the selected path; and
wherein the selected path is used for transmitting data for migrating the virtual machine from a first storage device location to a second storage device location.

9. The system of claim 8, wherein the path rank is maintained in a searchable data structure by the management console.

10. The system of claim 9, wherein the path rank is lowered when an attempt to transmit virtual machine migration data fails.

11. The system of claim 8, wherein the management console maintains attributes of the virtual network in the virtual network data structure.

12. The system of claim 11, wherein the attributes include storing a virtual network identifier; information regarding a plurality of components within the selected path of the virtual network and a path rank for the selected path.

13. The system of claim 8, wherein the path rank is based on a success rate and a failure rate for transmitting data for the virtual machine.

14. The system of claim 8, wherein a switch in the selected path identifies data for migrating the virtual machine and transmits the data using a higher priority.

15. A machine implemented method for a network executing a plurality of virtual machines accessing storage devices via a plurality of switches, comprising:
generating a virtual network data structure for a virtual network for identifying a plurality of network elements in a selected path from among a plurality of paths between a computing system executing the plurality of virtual machines and a storage device; wherein each path is ranked by a path rank and includes at least one switch that can identify traffic related to a virtual machine; and
using the selected path for transmitting data for migrating the virtual machine from a first storage device location to a second storage device location.

16. The method of claim 15, wherein the path rank is maintained in a searchable data structure by a processor executable application.

17. The method of claim 16, wherein the path rank is lowered when an attempt to transmit virtual machine migration data fails.

18. The method of claim 15, wherein a processor executable application maintains attributes of the virtual network in the virtual network data structure.

19. The method of claim 18, wherein the attributes include storing a virtual network identifier; information regarding a plurality of components within the selected path of the virtual network and a path rank for the selected path.

20. The method of claim 15, wherein the path rank is based on a success rate and a failure rate for transmitting data for the virtual machine.

21. The method of claim 15, wherein a switch in the selected path identifies data for migrating the virtual machine and transmits the data using a higher priority than non-virtual machine migration data.
